(19) United States
(12) Patent Application Publication
(10) Pub. No.: US 2025/0251970 A1
(43) Pub. Date: Aug. 7, 2025

(54) Autonomous Job Scheduler Orchestration Engine for Distributed Ledger Technology Leveraging Photonic Quantum Computing

(71) Applicant: Bank of America Corporation, Charlotte, NC (US)

(72) Inventors: Shailendra Singh, Maharashtra (IN); Krishna Rangarao Mamadapur, Maharashtra (IN)

(21) Appl. No.: 18/430,880

(22) Filed: Feb. 2, 2024

(51) Int. Cl. G06F 9/48; G06F 9/46

(52) U.S. Cl. CPC G06F 9/4881; G06F 9/466

(57) ABSTRACT

An autonomous job scheduling system for distributed ledger technology is disclosed, leveraging photonic quantum computing and generative artificial intelligence (AI). The system collects transactional and operational data from various nodes within a distributed ledger network, focusing on transaction types, sizes, and priorities. This data is filtered for urgency and resource intensity, analyzed against real-time network conditions and business rules to ascertain job execution parameters. A photonic quantum computing system processes these parameters to optimize job scheduling strategies, including quantum annealing and simulations. The AI engine generates dynamic smart contracts deployed to distributed ledgers by a job orchestration engine. The system monitors job execution, gathering performance data and providing feedback for real-time adjustments. The job orchestration engine updates job scheduling in response to these adjustments, enhancing the efficiency and responsiveness of the blockchain network.

### TECHNICAL FIELD

The present disclosure relates to data processing-artificial intelligence (AI) and, more particularly, to AI-based job scheduling and optimization in blockchain networks.

### DESCRIPTION OF THE RELATED ART

The problems addressed by this disclosure relate to the static and manual nature of current job scheduling in blockchain networks, which includes tasks such as monitoring token distribution, governance processes, data backups, and security audits. In other words, it refers to the inefficiency of job scheduling in blockchain distributed ledger networks. In such networks, job scheduling is critical for the efficient execution of various tasks that are essential to the network's reliability, security, and performance. Some of the critical job scheduling activities are:
a. Monitoring: Keeping track of the network's operation and health.
b. Token Distribution: Managing the allocation of tokens to various stakeholders.
c. Governance Processes: Overseeing the decision-making processes that affect the blockchain's protocols and rules.
d. Data Backups: Ensuring data is regularly saved and can be restored in case of loss.
e. Chain Fork Resolution: Handling situations where the blockchain diverges into two potential paths forward.
f. Security Audits: Checking the network for vulnerabilities and possible security breaches.
g. Resource Allocation: Distributing computational and storage resources efficiently.
h. Event Triggered Actions: Responding to specific events that occur within the blockchain.
i. Token Burn or Creation: Regulating the supply of tokens by removing or creating them.

Current systems for handling these activities are static, which means they operate on a fixed schedule or set of rules and cannot adapt dynamically to network changes. Furthermore, any optimization of job scheduling is performed manually, which can be time-consuming and error prone.

The problems with current blockchain job scheduling systems are multi-faceted:
a. Inflexibility: Traditional job scheduling in blockchain is static, meaning that tasks are set to run on a fixed schedule, regardless of the current network conditions or demands. This rigidity can lead to inefficiencies, such as resources being used to execute tasks at times when they are not actually needed, or urgent jobs not being prioritized when unexpected situations arise.
b. Manual Optimization: The optimization of job schedules, which involves rearranging the timing and resources allocated to tasks to make them more efficient, is currently a manual process. This can be very labor-intensive and may require specialized knowledge of both the blockchain network and the tasks it performs. Human error, delays in decision-making, and the inability to respond in real-time to network changes are significant drawbacks of this approach.
c. Resource Utilization: Static scheduling does not allow for dynamic resource allocation, meaning that computational and storage resources may not be used to their fullest potential. For instance, if a task is scheduled to run during a time of low network activity, it may not utilize available resources efficiently, or conversely, it may compete for resources during peak times, leading to congestion and performance issues.
d. Scalability Challenges: As the network grows and the number and complexity of tasks increase, the manual effort required to optimize job scheduling scales accordingly. This can lead to bottlenecks and increased chances of errors, making the system less scalable and adaptable to growth.
e. Lack of Responsiveness: With static schedules, the system is not equipped to handle spontaneous events or changes in the network effectively. For instance, in the event of a chain fork, a rapid response is necessary to resolve conflicts and maintain network integrity, which static scheduling cannot provide.
f. Security Risks: Scheduled tasks like security audits, if predictable, could potentially be targeted by malicious actors. They could time attacks around these schedules or take advantage of the time gaps between these tasks.
g. Governance and Compliance Issues: Governance processes that are not responsive to the current state of the network may fail to enforce policies or react to governance events in a timely fashion, leading to potential non-compliance with regulatory requirements or agreed-upon protocols.

As a result, there has long been a perceived and unmet need for an autonomous system capable of adapting job scheduling in real time to meet the network's immediate needs and priorities. This system should be designed to learn from the network's ongoing activities and adjust its scheduling parameters, accordingly, ensuring optimal performance without the need for constant human oversight. There is also a long-standing and unfulfilled need to create an autonomous job scheduler orchestration engine designed specifically for distributed ledger technology. This engine could automatically optimize jobs and schedule activities based on the environment and business rules. Such a system could dynamically adjust to changing network conditions, increasing efficiency, and potentially reducing the need for manual intervention. This would result in a more resilient and responsive blockchain network, with job schedules tailored in real time to meet the network's current needs and priorities.

### SUMMARY OF THE INVENTION

In accordance with one or more arrangements of the non-limiting sample disclosures contained herein, solutions are provided to address one or more of the above issues and problems with blockchain job scheduling (e.g., its static nature and manual optimization process, which can lead to inefficiencies such as redundant jobs and unnecessary consumption of network bandwidth) by, inter alia: providing an intelligent, autonomous job scheduling solution that leverages quantum computing and generative AI to significantly enhance the performance of blockchain networks and to automate and optimize job scheduling within a blockchain environment.

Advanced methods for job scheduling in blockchain networks are disclosed. Systems employ photonic quantum computing and generative AI to dynamically create and manage smart contracts for job scheduling. Methods can include an autonomous job orchestration engine that adapts job scheduling in real-time based on network conditions and resource availability, like CPU and memory. The goal is to optimize job scheduling within blockchain and distributed ledger technologies. The system seeks to enhance the efficiency and reduce latency in executing transactions on the blockchain by leveraging quantum computing, specifically photonic quantum computing, which uses photons for processing and is scalable due to its less complex hardware requirements compared to other quantum computing methods.

In some arrangements, sample innovative components and functionalities of the systems and methods can include one or more of:
a. Use of Quantum Computing: The system uses quantum computing to handle the massive data distributed across nodes in a blockchain. Quantum computing is known for its ability to perform complex calculations at incredible speeds, which is particularly beneficial when dealing with the high-volume, high-complexity data inherent in blockchain technologies.
b. Photonic Quantum Computing: Unlike traditional quantum computing, which requires extreme conditions, photonic quantum computing uses light (photons) for processing data. This approach is not only less resource-intensive but also offers potential for greater scalability. The hardware is simpler, avoiding the complex cooling systems that other quantum computing methods require.
c. Generative AI: The system employs generative AI to formulate dynamic smart contracts based on feedback from the quantum optimization engine. These AI-generated contracts are pivotal in automating the scheduling of tasks on the blockchain, ensuring they occur at the optimal time and under the best conditions, thus improving the efficiency of the entire network.
d. Autonomous Orchestration Engine: An autonomous orchestration engine can analyze, optimize, and manage job schedules. It is capable of identifying and eliminating redundant jobs, merging similar tasks to reduce workload, and dynamically adjusting the scheduling of tasks based on real-time network conditions.
e. Job Analysis: The system can include a sophisticated job analysis module that collects data about transaction contexts, business rules, and network run-time parameters. This module helps understand the operational state of the blockchain and provide the data necessary for optimization.
f. Dynamic Adaptability: Traditional blockchain job scheduling is static, but the inventions disclosed herein introduce dynamic scheduling that can adapt on-the-fly to changes in network conditions, such as unexpected latency or bandwidth issues. This adaptability ensures that jobs are not only executed according to plan but also reorganized as necessary to maintain network performance.
g. System-wide Optimization: The system's ability to analyze and optimize jobs extends to ensuring that resources are not wasted on outdated or unnecessary tasks. By continuously analyzing job logs and network telemetry, the engine can decommission obsolete jobs and merge overlapping tasks, thus freeing up resources and reducing latency.
h. Smart Contract Deployment: The generative AI engine creates smart contracts that contain the logic for the optimized scheduling of jobs. These contracts are dynamically generated and deployed on the blockchain, where they execute autonomously.
i. Application Scope: The disclosed systems and methods are applicable to a wide range of blockchain-based systems, including both public and private networks. It is especially useful for decentralized finance applications, where efficient, reliable job scheduling is essential for the network's trustworthiness and performance.
j. Manual vs. Autonomous: The current approach to job scheduling in blockchain environments typically involves manual analysis and optimization, which is time-consuming and prone to human error. In contrast, this new system is autonomous, continuously learning and adapting without the need for manual intervention.

In some arrangements, sample innovative features of the systems and method can include one or more of:
a. Monitoring and Analysis: It constantly reviews job relevance, suggesting removal or merging of jobs and adjusting schedules based on resource availability.
b. Job Analysis Engine: This collects network performance data and feeds it into the quantum optimization engine to generate job sequence rules.
c. Autonomous Generation: The system autonomously creates a dynamic job schedule map that is deployed automatically across the distributed ledger infrastructure.
d. Leveraging Quantum Generative AI: It merges jobs, purges obsolete ones, and adjusts redundant jobs within the distributed ledger environment.

In some arrangements, exemplary innovative system components and processes involved can include one or more of:
a. Intelligent Autonomous Job Scheduling Engine: This is a system designed to manage the timing and allocation of tasks (jobs) within a blockchain network autonomously. It uses advanced computing methods to optimize the scheduling of these tasks without the need for manual intervention.
b. Dynamic Smart Contract Generation: The system creates smart contracts dynamically, which are self-executing contracts with the terms of the agreement between buyer and seller being directly written into lines of code. It uses feedback from a photonic quantum optimization engine—this means it leverages the principles of quantum computing, which can process vast amounts of data at unprecedented speeds, to determine the most efficient way to schedule jobs.
c. Generative AI: Generative AI refers to the subset of AI that can generate new content or data that resembles existing data. In this context, it uses the strategy provided by the quantum optimization engine to encode rules into smart contracts. These rules govern how jobs should be scheduled on the blockchain autonomously.
d. Job Orchestration Engine: This engine acts upon the insights and analysis of current jobs to make decisions such as:
   i. Obsolescence: Determining if a job's output is no longer needed and thus can be retired.
   ii. Merging: Combining similar jobs, which could save resources and reduce redundancy.
   iii. Resource-based Scheduling: Adjusting the job schedules based on the availability of computational resources like CPU and memory.
e. Job Analysis Engine: This component collects real-time data about the blockchain's operation, such as transaction throughput, latency, bandwidth, block confirmation times, and more. This data is crucial for the photonic quantum optimization engine to set the rules for job sequencing.
f. Dynamic Scheduling: The method regularly updates the job schedule map, reflecting changes in the network's conditions or the jobs themselves. This updated map is automatically deployed across the distributed ledger ecosystem, ensuring that the blockchain operates efficiently.
g. Auto-Merging and Adjustment: To further enhance efficiency, the system has the ability to merge overlapping or redundant jobs and purge those that are no longer necessary. It does this autonomously, continually refining the job process flow to ensure optimal performance of the blockchain network.

In some arrangements, the intelligent, quantum computing-enhanced job scheduling system for distributed ledger networks, can be structured into three main steps:
a. Job Analysis Module: This first step involves gathering essential operational data from the blockchain network. This data includes the transaction context, business rules, and a variety of real-time network parameters like transaction throughput, latency, bandwidth, block confirmation times, block sizes, validation times, and available storage resources. These parameters are crucial for understanding the current state and performance of the blockchain network.
b. Quantum Computing System: The collected data is then fed into a quantum computing system for analysis. This system uses the superior processing power of quantum mechanics to:
   i. Identify and suggest alternative routes or paths for jobs to avoid latency or bottlenecks.
   ii. Recommend the merging of jobs with identical inputs and outputs to streamline processes and reduce redundancy.
   iii. Advise on splitting jobs to enhance their performance and the overall efficiency of their execution.
c. Job Modulation Module: In the final step, the Job Modulation Module takes the suggestions from the quantum computing system and implements them. This module adjusts the job scheduler to reroute, merge, or split jobs as advised, optimizing the job scheduling on the distributed ledger.

The overarching goal of this technical solution is to automate and optimize job scheduling in blockchain networks by leveraging quantum computing to quickly analyze complex data and make intelligent adjustments to the job scheduling process, thus improving the efficiency and responsiveness of the network.

In some arrangements, the autonomous job scheduling system for distributed ledger networks involves a detailed and interconnected process. The system starts by collecting a wide range of data from network nodes, which is then filtered for priority and resource intensity. This data is analyzed against real-time network conditions and business rules. A photonic quantum computing system processes this information, optimizing job scheduling strategies. These strategies are used by an AI engine to generate dynamic smart contracts, which are then deployed for job execution on the blockchain. The system continuously monitors job execution, adjusting parameters and updating schedules in real time to optimize network performance. This process includes prioritizing transactions, adapting to business rule changes, using quantum annealing for critical transactions, and applying AI for contract logic improvement. Additionally, the system includes verification processes for smart contract compliance and real-time job performance comparisons, utilizing predictive analysis for preemptive adjustments.

In some arrangements, methods can involve an automated process for managing jobs on a blockchain network. Data is collected from nodes, filtered for priority, and analyzed against business rules. A quantum system optimizes job schedules, and an AI engine generates smart contracts from these schedules. Jobs are then executed according to these contracts, with performance monitored for real-time adjustments. The system prioritizes transactional data and adapts to changing business rules. Quantum annealing is used to align job scheduling with critical transactions, and an AI improves contract logic via reinforcement learning. Verification ensures smart contract compliance, and a real-time comparison of job execution is performed. Predictive analysis helps adjust jobs in anticipation of network changes.

In some arrangements, the system architecture can include modules for data reception, analysis, quantum computing, AI, orchestration, and monitoring, working together to maintain optimal network operation. The data module filters transaction data, the analysis module adapts parameters in real time, and the quantum module solves optimization problems. The AI module uses predictions to balance the network load, and the smart contracts include conditional execution rules. Sensors monitor performance, and the AI updates contracts based on feedback. A rollback feature and user interface allow for manual overrides. The system is designed to handle various applications and optimize different network parameters autonomously.

By integrating these advanced technologies, the systems and methods disclosed herein create an efficient, responsive, and self-sustaining blockchain network that can adapt to changing conditions and demands without the need for constant human oversight. This can revolutionize how distributed ledger technology operates, making it far more scalable and robust.

Considering the foregoing, the following presents a simplified summary of the present disclosure to provide a basic understanding of various aspects of the disclosure. This summary is not limiting with respect to the exemplary aspects of the inventions described herein and is not an extensive overview of the disclosure. It is not intended to identify key or critical elements of or steps in the disclosure or to delineate the scope of the disclosure. Instead, as would be understood by a personal of ordinary skill in the art, the following summary merely presents some concepts of the disclosure in a simplified form as a prelude to the more detailed description provided below. Moreover, sufficient written descriptions of the inventions are disclosed in the specification throughout this application along with exemplary, non-exhaustive, and non-limiting manners and processes of making and using the inventions, in such full, clear, concise, and exact terms to enable skilled artisans to make and use the inventions without undue experimentation and sets forth the best mode contemplated for carrying out the inventions.

In some arrangements, a computer-implemented method for job scheduling in a distributed ledger environment can include one or more of the following steps such as, for example:
a. receiving, at a data reception module, a range of transactional and operational data from a plurality of nodes within a distributed ledger network, wherein the data includes details of transaction types, sizes, and priorities;
b. filtering, by the data reception module, the received transactional data based on predefined criteria including transaction urgency and resource intensity;
c. analyzing, by a job analysis module, the filtered data to ascertain job execution parameters, wherein the analysis involves evaluating against real-time network conditions and an array of business rules applicable to transaction processing within the distributed ledger network;
d. processing, by a photonic quantum computing system, the job execution parameters to optimize job scheduling strategies, the processing including quantum annealing and simulations to resolve complex scheduling scenarios;
e. generating, by a generative artificial intelligence (AI) engine interfaced with the photonic quantum computing system, dynamic smart contracts that encapsulate the optimized job scheduling strategies, wherein the generation includes encoding conditional execution logic based on real-time network bandwidth availability;
f. deploying, by a job orchestration engine, the dynamic smart contracts to one or more target distributed ledgers within the blockchain network;
g. executing, by the job orchestration engine, jobs on the target distributed ledger in accordance with the encoded scheduling rules, and wherein the execution includes a sequence of operations determined based on the optimized job scheduling strategies;
h. monitoring, by a system monitoring module, the execution of jobs on the distributed ledger and gathering comprehensive performance data including system load and transaction confirmation times;
i. providing, by the system monitoring module, feedback to the job analysis module based on the monitoring, wherein the feedback includes data indicative of network performance deviations from an optimal state;
j. adjusting, in real-time by the job analysis module, the job execution parameters in response to the feedback to improve job execution efficiency and network performance;
k. dynamically updating, by the job orchestration engine, the job scheduling on the distributed ledger in response to the adjusted job execution parameters to maintain or enhance optimal network operation;
l. prioritizing the transactional data based on the urgency associated with each transaction type during the filtering step; and/or
m. analyzing the filtered data further includes adapting the job execution parameters based on real-time changes to the predefined business rules and the priorities established.

In some arrangements, the quantum annealing and simulations are specifically configured to prioritize job scheduling strategies that align with the most critical transaction types as identified in the prioritization step.

In some arrangements, the generative AI engine utilizes a reinforcement learning algorithm to iteratively improve the conditional execution logic within the dynamic smart contracts based on historical network performance data.

In some arrangements, the deployment of dynamic smart contracts includes a verification process to ensure the smart contracts' conditional logic is compliant with the current operational state of the target distributed ledgers.

In some arrangements, the job orchestration engine is configured to execute a real-time comparison between scheduled job execution and actual job performance to identify discrepancies.

In some arrangements, the feedback provided includes predictive analysis based on trend data to preemptively adjust job execution parameters in anticipation of network load changes.

In some arrangements, a distributed ledger job scheduling system can include one or more of:
a. a data reception module configured to autonomously receive and interpret transactional and operational data from multiple nodes within a distributed ledger network;
b. an analysis module linked to the data reception module, the analysis module configured to process the received data to ascertain job execution parameters based on current network conditions and predefined business rules;
c. a quantum computing module operatively coupled to the analysis module, the quantum computing module comprising a photonic processor capable of performing quantum computations to optimize job scheduling strategies based on the execution parameters;
d. a generative artificial intelligence (AI) module configured to receive optimized strategies from the quantum computing module and generate dynamic smart contracts that encode job scheduling rules tailored to optimize transaction throughput, reduce latency, and efficiently allocate network bandwidth and storage resources;
e. an orchestration module communicatively connected to the AI module, the orchestration module adapted to deploy the generated smart contracts to the distributed ledger and initiate job execution in accordance with the scheduling rules; and/or
f. a monitoring module configured to continuously evaluate the execution of jobs on the distributed ledger, provide feedback to the analysis module, and adjust the job execution parameters in real time, wherein the orchestration module dynamically updates the job scheduling in response to the feedback to maintain optimal network operation.

In some arrangements, the data reception module is further configured to filter transactional data based on transaction type, size, or priority status.

In some arrangements, the analysis module includes a business logic interpreter capable of adapting the job execution parameters in real time based on changes in the predefined business rules and the filtered transactional data.

In some arrangements, the quantum computing module comprises a photonic quantum processor integrated with an annealing mechanism for solving optimization problems related to job scheduling derived from the adapted job execution parameters.

In some arrangements, the AI module includes a neural network trained to predict future network conditions based on historical data patterns and the received optimized strategies from the photonic quantum processor.

In some arrangements, the orchestration module is further configured to sequence job execution across multiple distributed ledgers to balance the network load, based on predictions made by the neural network.

In some arrangements, the dynamic smart contracts generated by the AI module include provisions for conditional execution based on real-time network bandwidth availability, as sequenced by the orchestration module.

In some arrangements, the monitoring module utilizes distributed sensors across the network nodes to gather comprehensive performance data for the feedback mechanism, influencing the conditional execution provisions in the dynamic smart contracts.

In some arrangements, the AI module is further configured to update the dynamic smart contracts autonomously in response to feedback indicating a deviation from optimal network performance, as determined by the monitoring module.

In some arrangements, the orchestration module includes a rollback feature to revert job schedules to a previous state in the event of network failure or performance degradation, as indicated by updates from the AI module.

In some arrangements, a system may further comprise a user interface module to allow administrators to manually override the autonomous scheduling decisions made by the system, including the rollback actions of the orchestration module.

In an autonomous job scheduling system for managing tasks within a distributed ledger network can include one or more of:
a. a job analysis module configured to collect operational data from the distributed ledger, including transaction context, business rules, and network performance metrics;
b. a photonic quantum computing system communicatively coupled with the job analysis module, the quantum computing system configured to receive the operational data and execute quantum computations to derive optimized job scheduling strategies;
c. a generative AI engine interfaced with the quantum computing system, the generative AI engine configured to formulate dynamic smart contracts incorporating the optimized job scheduling strategies; and/or
d. a job orchestration engine operatively connected to the generative AI engine, the job orchestration engine adapted to deploy and execute the dynamic smart contracts on the distributed ledger, thereby scheduling jobs in accordance with the optimized strategies.

In some arrangements, one or more various steps or processes disclosed herein can be implemented in whole or in part as computer-executable instructions (or as computer modules or in other computer constructs) stored on computer-readable media. Functionality and steps can be performed on a machine or distributed across a plurality of machines that are in communication with one another.

In summary, the inventions disclosed herein represent a significant leap forward in the management of blockchain networks. They bring a high degree of intelligence and automation to a process that has traditionally been manual and static, offering the promise of significantly enhanced efficiency, reliability, and scalability for blockchain technologies.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

FIG. 1 depicts an architectural and flow diagram showing sample interactions, interfaces, steps, functions, and components in accordance with one or more aspects of this disclosure to explain the system's components, the process of how it works, and the interaction between the quantum computing elements and job scheduling mechanisms.

FIG. 2 depicts dynamic job schedule configuration maps with multidimension optimization parameters (e.g., transaction throughput, latency, network bandwidth, block confirmation time, block size, validation time, storage resource, etc.) on a temporal axis in accordance with one or more aspects of this disclosure.

FIG. 3 depicts a flow diagram for an intelligent-environment and rule-based autonomous, job-scheduler, orchestration engine for distributed ledger technology leveraging photonic quantum computing showing sample interactions, interfaces, steps, functions, and components in accordance with one or more aspects of this disclosure to explain the system's components, the process of how it works, and the interaction between the quantum computing elements and job scheduling mechanisms.

FIG. 4 depicts another sample flow diagram showing sample interactions, interfaces, steps, functions, and components in accordance with one or more aspects of this disclosure.

### DETAILED DESCRIPTION

In the following description of the various embodiments to accomplish the foregoing, reference is made to the drawings, which form a part hereof, and in which is shown by way of illustration, various embodiments in which the disclosure may be practiced. It is to be understood that other embodiments may be utilized, and structural and functional modifications may be made. It is noted that various connections between elements are discussed in the following description. It is noted that these connections are general and, unless specified otherwise, may be direct or indirect, wired, or wireless, and that the specification is not intended to be limiting in this respect.

As used throughout this disclosure, any number of computers, machines, or the like (referenced interchangeably herein depending on context) can include one or more general-purpose, customized, configured, special-purpose, virtual, physical, and/or network-accessible devices as well as all hardware/software/components contained therein or used therewith as would be understood by a skilled artisan, and may have one or more application specific integrated circuits (ASICs), microprocessors, cores, executors etc. for executing, accessing, controlling, implementing etc. various software, computer-executable instructions, data, modules, processes, routines, or the like as explained below. References herein are not considered limiting or exclusive to any type(s) of electrical device(s), or component(s), or the like, and are to be interpreted broadly as understood by persons of skill in the art. Various specific or general computer/software components, machines, or the like are not depicted in the interest of brevity or discussed herein in detail because they would be known and understood by ordinary artisans.

Software, computer-executable instructions, data, modules, processes, routines, or the like can be on tangible computer-readable memory (local, in network-attached storage, be directly and/or indirectly accessible by network, removable, remote, cloud-based, cloud-accessible, etc.), can be stored in volatile or non-volatile memory, and can operate autonomously, on-demand, on a schedule, spontaneously, proactively, and/or reactively, and can be stored together or distributed across computers, machines, or the like including memory and other components thereof. Some or all the foregoing may additionally and/or alternatively be stored similarly and/or in a distributed manner in the network accessible storage/distributed data/datastores/databases/big data/blockchains/distributed ledger blockchains etc.

As used throughout this disclosure, computer “networks,” topologies, or the like can include one or more local area networks (LANs), wide area networks (WANs), the Internet, clouds, wired networks, wireless networks, digital subscriber line (DSL) networks, frame relay networks, asynchronous transfer mode (ATM) networks, virtual private networks (VPN), or any direct or indirect combinations of the same. They may also have separate interfaces for internal network communications, external network communications, and management communications. Virtual IP addresses (VIPs) may be coupled to each if desired. Networks also include associated equipment and components such as access points, adapters, buses, ethernet adaptors (physical and wireless), firewalls, hubs, modems, routers, and/or switches located inside the network, on its periphery, and/or elsewhere, and software, computer-executable instructions, data, modules, processes, routines, or the like executing on the foregoing. Network(s) may utilize any transport that supports HTTPS or any other type of suitable communication, transmission, and/or other packet-based protocol.

Generative Artificial Intelligence (AI) refers to AI techniques that learn a representation of training data and use it to generate new content that is similar to or inspired by existing data. Generated content may include human-like outputs such as natural language text, source code, images/videos, and audio samples. Generative AI solutions typically leverage open-source or vendor sourced (proprietary) models, and can be provisioned in a variety of ways, including, but not limited to, Application Program Interfaces (APIs), websites, search engines, and chatbots. Most often, Generative AI solutions are powered by Large Language Models (LLMs) which were pre-trained on large datasets using deep learning with over 500 million parameters and reinforcement learning methods. Any usage of Generative AI and LLMs is governed by the Enterprise AI Policy and Enterprise Model Risk Policy.

Example models: OpenAI GPT Models (proprietary), Meta Llama Models (open-sourced) Example Generative AI/LLM use cases: generating human-like text, searching and retrieving information, summarizing text, performing classification, understanding natural language and answering questions, analyzing sentiment, filtering content, translating language, assisting with computer code, generating content for creative applications and more.

As explained in the context of the systems and methods disclosed herein, job scheduling activities in a blockchain network are a set of coordinated processes that ensure the smooth and secure functioning of the network. Each activity plays a specific role in maintaining the blockchain's operations, integrity, and security. Here's an expanded explanation of these activities:
a. Consensus Mechanism Execution: In blockchain, the consensus mechanism is the process used to achieve agreement on a single data value among distributed processes or systems. It is essential for maintaining the uniformity and reliability of the data (transactions) across all nodes in the network. For example, Bitcoin uses a proof-of-work system that requires substantial computational resources to solve complex mathematical puzzles for validating transactions.
b. Block Creation and Mining: This involves creating new blocks to add to the blockchain. Miners use computational power to solve cryptographic puzzles, and once a puzzle is solved, the miner can add a new block, which then gets verified by other nodes. This process not only adds new transactions to the blockchain but also generates new tokens as rewards for the miners.
c. Smart Contract Execution: Smart contracts are automated contracts with self-executing rules. Scheduling the execution of these contracts involves invoking the contract's code when specific conditions are met, without the need for a middleman.
d. Node Maintenance: Nodes, the individual parts of the larger data structure that is a blockchain, require regular maintenance. This includes software updates, security patches, and other optimizations to keep the network running smoothly and securely.
e. Transaction Validation: Before a transaction can be added to a block, it must be validated by nodes. This process involves checking the transaction's validity against the blockchain's history to prevent fraud such as double spending.
f. Network Monitoring: Continuous monitoring of the blockchain network is essential to detect any unusual activity or malfunctions. This can include monitoring for potential security threats, checking the balance of the network's nodes, and ensuring transactions are being confirmed in a timely manner.
g. Token Distribution: Blockchain networks often have native tokens or cryptocurrencies that need to be distributed to network participants. This might be done as a reward for mining, staking, or participating in the network in other ways, and requires careful scheduling and execution.
h. Governance Processes: These processes involve managing the rules that govern the blockchain network. This might include consensus selection of protocol changes or implementing upgrades, which often require coordination across a decentralized network of stakeholders.
i. Data Backups: Regular backups of the blockchain are critical to recover from system failures, cyberattacks, or data corruption. This ensures the integrity and continuity of the network's historical data.
j. Chain Fork Resolution: Forks occur when there is a divergence in the blockchain, creating two potential paths forward. Resolving forks is critical to maintain a single, consistent ledger and can involve complex coordination among network participants.
k. Security Audits: Regular security audits are necessary to identify and rectify vulnerabilities in a blockchain network. These audits must be scheduled and conducted methodically to maintain the network's security posture.
l. Resource Allocation: This involves the distribution of computational and other resources among the nodes to ensure efficient operation of the network. It must be managed in real-time to adapt to the constantly changing demands on the network.
m. Event Triggered Actions: These are actions that are executed in response to certain triggers or events, such as fluctuations in network activity or security breaches. They require the network to be constantly observant and responsive.
n. Token Burn or Creation: This refers to the intentional destruction (burning) or creation (minting) of tokens to control supply and provide economic stability or incentives within the blockchain ecosystem. It must be managed to prevent inflation or deflation.

Each of these activities is crucial for the network's overall health and functionality. They must be executed with precision and in accordance with the network's rules to maintain a secure, efficient, and reliable blockchain. The systems and methods disclosed herein accomplish this by automating and optimizing job scheduling within a blockchain environment, leveraging advanced technologies like photonic quantum computing and generative AI.

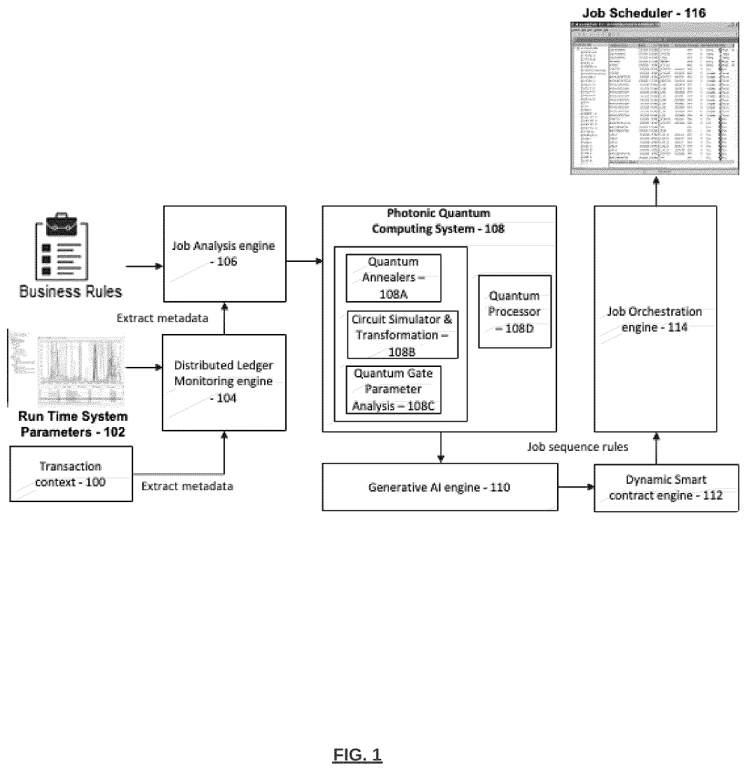

By way of non-limiting disclosure, FIG. 1 depicts an architectural and flow diagram showing sample interactions, interfaces, steps, functions, and components in accordance with one or more aspects of this disclosure to explain the system's components, the process of how it works, and the interaction between the quantum computing elements and job scheduling mechanisms.

The intelligent environment and business rule based self job scheduler modulation apparatus, as illustrated, operates within a distributed ledger environment, like a blockchain, and leverages Quantum Computing to optimize job scheduling. The technical solution aims to revolutionize job scheduling in distributed ledger technology (DLT) platforms, such as blockchains, by introducing a smart, self-regulating system that uses quantum computing to optimize tasks. The process is divided into three primary steps:
a. Job Analysis Module: This module is responsible for collecting a wide array of data pertinent to the operation of the distributed ledger. This module serves as the data collection hub of the system. It meticulously gathers details about each transaction (the context), applies the governing business rules of the blockchain, and captures real-time operational metrics of the network. The job analysis metrics help provide a comprehensive picture of the blockchain network's performance and identifies areas for optimization. Sample metrics include:
   i. Transaction Throughput: This metric measures the number of transactions that the network can process over a certain period. High throughput is indicative of a robust system that can handle a large volume of transactions efficiently, while low throughput can signal bottlenecks that may need addressing.
   ii. Latency: Latency refers to the delay from the initiation of a transaction to its confirmation. In blockchain networks, this delay can be affected by various factors, including network congestion and the time it takes for a transaction to be included in a block. Reducing latency is crucial for time-sensitive applications and enhances the user experience.
   iii. Network Bandwidth: The network bandwidth is the volume of data that can be transmitted through the blockchain network within a given timeframe. It's a critical factor in determining the network's capacity to handle large-scale operations and simultaneous transactions.
   iv. Block Confirmation Time: This is the time required for a new block of transactions to be verified and added to the blockchain. It's a vital component of the network's security and efficiency, as faster block confirmation can lead to improved transaction speeds and increased trust in the blockchain's immutability.
   v. Block Size: The size of a block in the blockchain dictates how many transactions it can contain. Block size is a contentious issue in many cryptocurrencies, as it directly impacts scalability-larger blocks can contain more transactions but may also require more processing power to validate.
   vi. Validation Time: Validation time measures the duration needed to check the authenticity and integrity of a transaction before it's accepted into a block. Efficient validation is essential to prevent fraud and ensure only legitimate transactions are recorded on the ledger.
   vii. Storage Resource: This metric assesses the amount of data storage available to the network. Adequate storage is necessary to maintain the blockchain's growing ledger and ensure that it remains operational without interruptions or performance degradation.

These metrics collectively inform the Job Analysis Module about the state of the network, allowing it to determine the most efficient ways to schedule and execute jobs. For instance, if the transaction throughput is low but the network bandwidth is underutilized, the system might identify an opportunity to increase the block size or reduce validation time. If latency is high, the system may look into optimizing the consensus mechanism or rerouting transactions through less congested pathways. The goal is to use these metrics not only to diagnose current performance issues but also to predict future bottlenecks and preemptively adjust the job scheduling to maintain an optimal state of network operation.

These collected parameters are then fed into the Quantum Computing system for analysis.
a. Quantum Computing System: Utilizing the principles of quantum computing, which can handle vast datasets and perform complex calculations rapidly, this system analyzes the parameters received from the Job Analysis Module. It then provides suggestions for job modulation, such as:
   i. Routing Optimization: If latency or bottlenecks are detected, it suggests alternative routes or paths for job execution to avoid these issues.
   ii. Job Merging: In cases where multiple jobs have the same inputs and outputs, the system may suggest combining them to streamline processes and eliminate redundancies.
   iii. Job Splitting: To enhance performance and efficiency, the system might recommend splitting larger jobs into smaller, more manageable tasks.
b. Job Modulation Module: Based on the quantum computing system's feedback, this module implements the suggested changes to the job schedule. This could include:
   i. Rerouting jobs to optimize for current network conditions.
   ii. Merging jobs to reduce duplication and improve efficiency.
   iii. Splitting complex jobs into simpler tasks to ensure faster and more reliable execution.
   iv. Through these steps, the apparatus aims to create a highly efficient, self-regulating job scheduler for blockchain networks that can respond in real-time to changing network conditions, optimize resource usage, and streamline the execution of jobs, thereby enhancing the overall performance and scalability of the distributed ledger system.

The diagram of FIG. 1 presents an advanced system architecture for optimizing job scheduling in a distributed ledger environment using quantum computing and artificial intelligence. Here's a detailed description of each component and the flow between them:
a. Transaction Context—100: This is the starting point of the process where the specific details of transactions are collected. This context can include transaction data such as sender, receiver, value, timestamps, etc.
b. Business Rules: These are predefined rules that could dictate how transactions are to be processed and managed within the system.
c. Distributed Ledger Monitoring Engine—104: This engine monitors the current state of the distributed ledger, possibly tracking metrics like transaction volume, block times, and network congestion.
d. Job Analysis Engine—106: This engine analyzes jobs, which could include transaction processing tasks or other network activities that need scheduling. It uses the data from the Transaction Context (100) and Business Rules, alongside insights from the Distributed Ledger Monitoring Engine (104), to make informed decisions.
e. Photonic Quantum Computing System—108: The core of the computational process, this system uses quantum mechanics to analyze data and perform calculations at high speeds. It is comprised of:
   i. Quantum Annealers—108A: Specialized quantum computing devices that may be used to find the optimal solutions to complex problems by settling into their lowest energy state.
   ii. Circuit Simulator & Transformation—108B: It simulates quantum circuits and can transform quantum states, which is crucial in modeling and understanding how quantum algorithms will behave.
   iii. Quantum Processor—108D: The component that performs the actual quantum computations.
   iv. Quantum Data Parameter Analysis—108C: This process likely involves analyzing the data received from the Job Analysis Engine (106) in terms of quantum parameters that are relevant for the quantum processor to understand and act upon.
f. Generative AI Engine—110: An AI system that uses the output from the Photonic Quantum Computing System (108) to generate or modify smart contracts or job schedules. It could be employing generative algorithms that adapt and learn from the data to improve over time.
g. Dynamic Smart Contract Engine—112: This engine dynamically generates or updates smart contracts based on the suggestions or parameters provided by the Generative AI Engine (110). These smart contracts are self-executing contracts with the terms of the agreement directly written into code and are used to automate the execution of transactions or jobs on the blockchain.
h. Job Orchestration Engine—114: The final step in the process where the jobs are scheduled and managed based on the optimized smart contracts provided by the Dynamic Smart Contract Engine (112). This engine ensures that jobs are carried out efficiently, in line with the optimized schedules and business rules.

Thus, the architecture and flow diagram of FIG. 1 illustrates a closed-loop system where transaction context and business rules inform the monitoring and analysis of jobs, which is then optimized using quantum computing. The optimized parameters are used by an AI engine to generate dynamic smart contracts, which are then enacted by a job orchestration engine to efficiently manage the distributed ledger's operations.

The systems and methods of FIG. 1 represent a highly sophisticated and intelligent procedure for autonomous job scheduling in blockchain technology. Itis designed to dynamically generate and manage smart contracts for job scheduling by leveraging both quantum computing and artificial intelligence capabilities. The following is an expanded summary of the technical solution and process:
a. Intelligent Technical Procedure: The method utilizes advanced computational technologies to intelligently manage and optimize the scheduling of jobs on a blockchain network. The ‘intelligent’ aspect implies that the system can make decisions and adapt without human intervention, while the ‘technical procedure’ indicates a systematic approach grounded in technology.
b. Autonomous Job Scheduling Engine: The engine autonomously handles the scheduling of tasks within a distributed ledger system, which means it operates independently, constantly adjusting job schedules based on the current state of the network. This is in contrast to traditional, static job scheduling methods that do not adapt to changing conditions.
c. Dynamic Smart Contract Creation: At the core of the system's functionality is the creation of smart contracts that are dynamic and capable of altering their rules for job scheduling in response to network conditions. These contracts are essential for executing tasks autonomously on the blockchain.
d. Quantum Optimization Feedback: The system employs a quantum computing system to analyze network data and provide feedback. This feedback is used by a generative AI to formulate dynamic smart contracts tailored to the current needs of the blockchain. Quantum computing offers significant speed and parallel processing advantages that are crucial for analyzing vast amounts of data across distributed nodes.
e. Generative AI: The AI component takes the feedback from the quantum optimization engine and generates code for smart contracts. These contracts contain rules for scheduling and are deployed on the blockchain to orchestrate job execution.
f. Job Analysis and Orchestration: The system analyzes jobs to determine if there are duplicates, potential mergers, or if certain jobs can be decommissioned to streamline the network's operations. It not only examines the job logs but also looks at the temporal properties to understand if the sequencing is optimal or if jobs could be executed in parallel to enhance efficiency.
g. Network Runtime Parameters and Business Logic: The job analysis module collects detailed information about network runtime parameters such as transaction throughput, latency, network bandwidth, and block confirmation times. This data, along with the business rules and the context of each transaction, is used to make scheduling decisions that optimize the network's performance.
h. Smart Contract Deployment: Once the optimal job scheduling strategy is determined, the generative AI encodes it into a smart contract, which is then deployed on the blockchain. This smart contract governs the execution of jobs according to the optimized schedule.
i. Infrastructure Optimization: The systems and methods seek to optimize key performance indicators (KPIs) of the blockchain infrastructure, such as reducing latency or maximizing throughput. This optimization is based on a deep understanding of both the technical performance metrics and the business logic that drives job execution.

In essence, this method is a complex and adaptive approach to managing blockchain operations that combines the cutting-edge capabilities of quantum computing with the adaptive, learning nature of AI. It transforms the way jobs are scheduled and executed in blockchain networks, making the process more efficient, less prone to errors, and significantly faster, which is particularly crucial for financial transactions and other time-sensitive operations in decentralized applications.

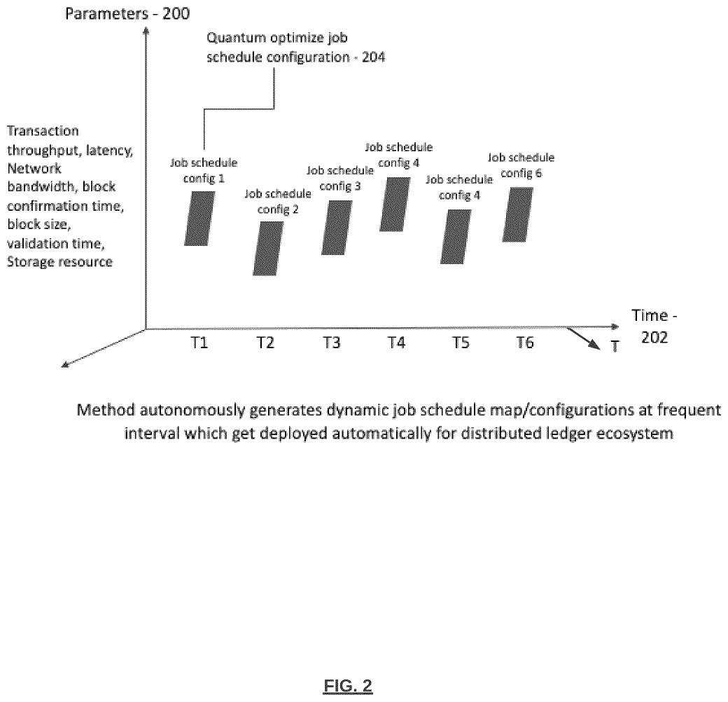

By way of non-limiting disclosure, FIG. 2 depicts dynamic job schedule configuration 204 that maps 204 multidimension optimization parameters 200 (e.g., transaction throughput, latency, network bandwidth, block confirmation time, block size, validation time, storage resource, etc.) on a temporal axis (wherein time is represented as 202) in accordance with one or more aspects of this disclosure. The method autonomously generates dynamic job schedule map/configurations at frequent interval which get deployed automatically for distributed ledger ecosystem.

As illustrated in FIG. 2, a sophisticated and autonomous job scheduling system for blockchain networks is provided that utilizes quantum computing and artificial intelligence to dynamically create and manage job schedules. Here is a summary and explanation of the technical solution:
a. Intelligent and Autonomous System: The method described is an advanced, intelligent procedure that autonomously manages job scheduling for blockchain technologies. It operates independently, requiring no manual intervention to continually adjust and optimize the scheduling of jobs.
b. Quantum System Optimization: The core of the process is a quantum computing system that receives various parameters related to job scheduling and uses its advanced computational capabilities to provide optimized scheduling strategies. This process takes into account a multitude of factors, including the operational conditions of the blockchain network and predefined business rules.
c. Generative AI and Smart Contract Formation: The optimized strategies from the quantum system are then fed to a generative AI, which translates these strategies into dynamic smart contracts. These contracts encode the rules for job scheduling and are deployed on the blockchain network to facilitate the execution of jobs.
d. Job Orchestration Engine: A job orchestration engine uses the smart contracts to trigger job executions on the blockchain. This allows for the scheduling of jobs to be adjusted in real time, ensuring the network operates efficiently.
e. Optimization of KPIs: The system aims to optimize key performance indicators such as transaction throughput, latency, and block confirmation time. It takes into account the various infrastructure elements and business insights to fine-tune the network's performance.
f. Adaptive Scheduling: The job scheduling can adapt to the specific needs of the network at any given time. For example, during periods of high transaction volume, the system might adjust the job scheduling to accommodate the increased load and reduce latency.
g. Hyperspace of Parameters: The complexity of optimization can increase with the number of parameters considered. The system can handle a hyperspace of conditions, optimizing multiple parameters simultaneously to find the best configuration for job scheduling.
h. Autonomy and Flexibility: The system is designed to automatically generate new configurations for job schedules at regular intervals or as network conditions change, similar to how an autopilot system adjusts an aircraft's controls in real time.
i. Temporal Adaptability: The system is temporally adaptive, meaning it can adjust the job scheduling based on time-variant factors such as peak transaction periods or seasonal changes in network activity.
j. Infrastructure Tool: This system acts as a tool or product that can be integrated with various blockchain applications within an organization's infrastructure, optimizing each application's performance and resource utilization.

In summary, the systems and methods are highly innovative and technical solutions that leverage the speed and parallel processing capabilities of quantum computing, alongside the adaptive nature of AI, to optimize job scheduling on blockchain networks. It is capable of handling complex and changing conditions, ensuring that the blockchain infrastructure operates at peak efficiency and stability.

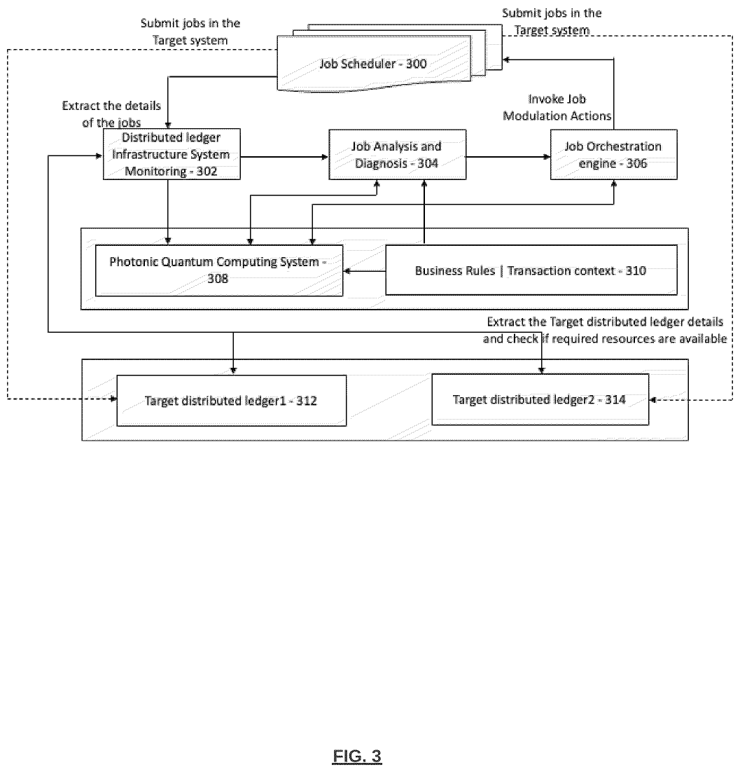

By way of non-limiting disclosure, FIG. 3 depicts a flow diagram for an intelligent-environment and rule-based autonomous, job-scheduler, orchestration engine for distributed ledger technology leveraging photonic quantum computing showing sample interactions, interfaces, steps, functions, and components in accordance with one or more aspects of this disclosure to explain the system's components, the process of how it works, and the interaction between the quantum computing elements and job scheduling mechanisms.

The FIG. 3 flowchart represents a complex and sophisticated job scheduling system that integrates quantum computing to manage and execute tasks within a blockchain network. Each component contributes to a seamless workflow that ensures jobs are processed efficiently and effectively across distributed ledgers. The elements and their interconnections can be understood as follows:
a. Job Scheduler—300: Serving as the command center, the Job Scheduler is where jobs are received for execution within the blockchain environment. It acts as a dispatcher, sorting and organizing tasks before they are analyzed and executed. The scheduler's role is to ensure that jobs are queued and processed in a manner consistent with the overall system's optimization strategies.
b. Job Analysis and Diagnosis—304: This component scrutinizes each job submitted by the Job Scheduler. It performs a diagnostic check, comparing the job requirements against the system's current status and operational criteria derived from business rules and real-time network analytics. This module assesses the jobs' feasibility, priority, and resource requirements, ensuring that only viable and necessary jobs proceed to the next stage.
c. Job Orchestration Engine—306: Acting upon the diagnostics from the previous step, the Job Orchestration Engine is responsible for the strategic execution of jobs. It modulates job actions, potentially rescheduling, reassigning, or restructuring tasks to optimize their execution based on current network conditions and the system's performance goals. This engine is the active agent that aligns job execution with the dynamic needs of the blockchain network.
d. Photonic Quantum Computing System—308: The use of photonic quantum computing represents a cutting-edge approach to data processing within the system. This quantum computing system is capable of performing highly complex calculations at extraordinary speeds, which is essential for real-time optimization in a variable and demanding blockchain environment. It processes vast amounts of data, including system monitoring outputs and business rules, to inform decisions and generate the most efficient scheduling strategies.
e. Business Rules/Transaction Context—310: This set of rules and contextual information provides the governance framework for the entire scheduling process. It includes the logic and conditions under which transactions and jobs should be processed, such as compliance with regulatory requirements, adherence to smart contract terms, or specific business objectives like minimizing transaction costs or maximizing speed.
f. Target Distributed Ledgers—312 & 314: These represent the end goal of the process, the blockchain platforms where the scheduled jobs are ultimately carried out. These could be separate blockchain environments, each with its own set of performance metrics, security requirements, and operational demands. The system's ability to target multiple distributed ledgers indicates a level of sophistication suitable for complex blockchain ecosystems with varied workloads.
g. System Monitoring—302: Continuously observes the distributed ledger infrastructure, collecting data on system performance, resource utilization, and other critical metrics that can impact job scheduling. This real-time monitoring enables the system to adapt to the network's ever-changing conditions.

The flow of the process illustrates a highly adaptive system capable of real-time decision-making. The Job Scheduler coordinates the initial receipt of jobs, which are then analyzed and diagnosed for optimal execution strategies. The Photonic Quantum Computing System plays a pivotal role in processing complex computations and providing data-driven insights to the Job Orchestration Engine, which then efficiently manages the actual job execution on the target distributed ledgers.

The use of photonic quantum computing indicates a system designed for scalability and speed, able to handle the vast amounts of data and complex computational tasks inherent in blockchain operations. By integrating business rules and real-time transaction contexts, the system ensures that all job scheduling aligns with strategic business objectives while also responding dynamically to the operational state of the blockchain network.

Overall, this system represents a cutting-edge approach to managing blockchain operations, with the potential to significantly enhance the performance and efficiency of distributed ledger technologies.

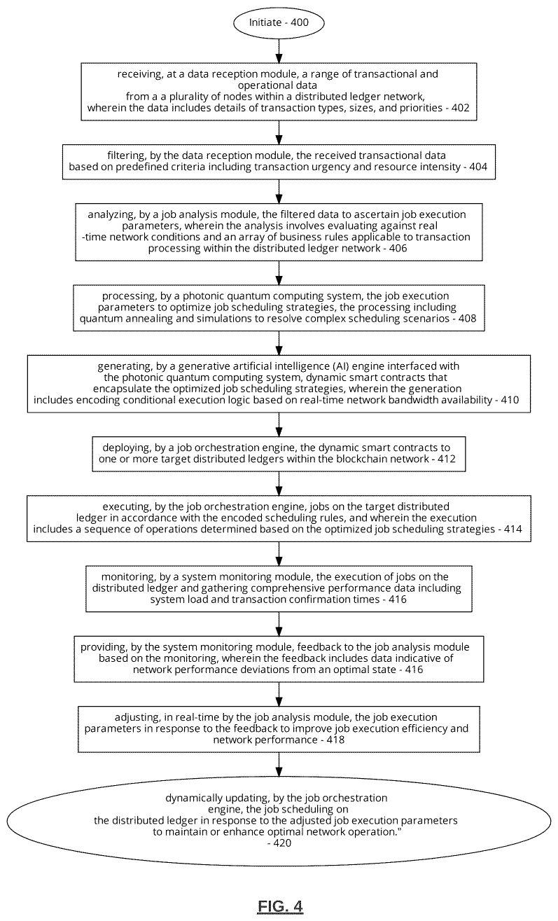

By way of non-limiting reference, FIG. 4 depicts another sample flow diagram showing sample interactions, interfaces, steps, functions, and components in accordance with one or more aspects of this disclosure.

The method begins with an initiation phase (400), where a data reception module commences the process of gathering a wide array of transactional and operational data from various nodes within a distributed ledger network. This data, identified in step (402), encompasses a detailed account of transaction types, sizes, and priorities, providing a holistic view of network activity.

Following the data collection, the data reception module proceeds to filter this information (404). Utilizing a set of predefined criteria, it scrutinizes the data for transaction urgency and resource intensity, ensuring that only the most relevant and critical data is forwarded for further analysis.

In step (406), a job analysis module takes over. This module delves into the filtered data to determine job execution parameters. It evaluates this information against the backdrop of real-time network conditions and a comprehensive suite of business rules specific to transaction processing within the distributed ledger environment. This analysis is critical in understanding the current state of the network and preparing for the next steps in job scheduling.

The method then advances to a critical phase involving a photonic quantum computing system (408). This advanced computing system employs quantum annealing and simulations to process the job execution parameters. Its goal is to devise optimized strategies for job scheduling, tackling complex scenarios that might arise in the network.

At the core of the system is a generative artificial intelligence (AI) engine (410). Interfaced with the photonic quantum computing system, this AI engine is responsible for creating dynamic smart contracts. These contracts encapsulate the optimized job scheduling strategies and incorporate conditional execution logic. This logic is fine-tuned based on the current availability of network bandwidth, ensuring adaptability and responsiveness to real-time network conditions.

The dynamic smart contracts, once generated, are deployed by a job orchestration engine (412). This engine sends the contracts to one or more target distributed ledgers within the blockchain network, setting the stage for the execution of jobs according to the prescribed rules.

Job execution (414) is carried out by the same orchestration engine. This step is not just a mere execution of tasks but includes a sequence of operations determined based on the optimized job scheduling strategies. This approach ensures that job execution is aligned with the overall objectives of the distributed ledger network.

Parallel to the execution phase is a continuous monitoring process (416). A dedicated system monitoring module oversees the job execution on the distributed ledger. It gathers comprehensive data on system load, transaction confirmation times, and other pertinent performance metrics, providing a clear view of how the network is functioning in real time.

Based on this monitoring, the system module provides feedback (418) to the job analysis module. This feedback contains insights into network performance, particularly highlighting any deviations from an optimal operational state.

In response to this feedback, the job analysis module adjusts job execution parameters in real time (418). This adjustment is aimed at enhancing the efficiency and performance of job execution, ensuring that the network operates at its best.

Finally, the job orchestration engine takes action once again (420). It dynamically updates the job scheduling on the distributed ledger in response to the adjusted job execution parameters. This ongoing adaptation is crucial to maintaining or enhancing the optimal operation of the distributed ledger network, ensuring that it can effectively respond to ever-changing demands and conditions.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A computer-implemented method for job scheduling in a distributed ledger environment, comprising:
receiving, at a data reception module, a range of transactional and operational data from a plurality of nodes within a distributed ledger network, wherein the data includes details of transaction types, sizes, and priorities;
filtering, by the data reception module, the received transactional data based on predefined criteria including transaction urgency and resource intensity;
analyzing, by a job analysis module, the filtered data to ascertain job execution parameters, wherein the analysis involves evaluating against real-time network conditions and an array of business rules applicable to transaction processing within the distributed ledger network;
processing, by a photonic quantum computing system, the job execution parameters to optimize job scheduling strategies, the processing including quantum annealing and simulations to resolve complex scheduling scenarios;
generating, by a generative artificial intelligence (AI) engine interfaced with the photonic quantum computing system, dynamic smart contracts that encapsulate the optimized job scheduling strategies, wherein the generation includes encoding conditional execution logic based on real-time network bandwidth availability;
deploying, by a job orchestration engine, the dynamic smart contracts to one or more target distributed ledgers within a blockchain network;
executing, by the job orchestration engine, jobs on the target distributed ledger in accordance with the encoded scheduling rules, and wherein the execution includes a sequence of operations determined based on the optimized job scheduling strategies;
monitoring, by a system monitoring module, the execution of jobs on the distributed ledger and gathering comprehensive performance data including system load and transaction confirmation times;
providing, by the system monitoring module, feedback to the job analysis module based on the monitoring, wherein the feedback includes data indicative of network performance deviations from an optimal state;
adjusting, in real-time by the job analysis module, the job execution parameters in response to the feedback to improve job execution efficiency and network performance; and
dynamically updating, by the job orchestration engine, the job scheduling on the distributed ledger in response to the adjusted job execution parameters to maintain or enhance optimal network operation.

2. The method of claim 1, further comprising prioritizing the transactional data based on the urgency associated with each transaction type during the filtering step.

3. The method of claim 2, wherein analyzing the filtered data further includes adapting the job execution parameters based on real-time changes to predefined business rules and priorities established.

4. The method of claim 3, wherein the quantum annealing and simulations are specifically configured to prioritize job scheduling strategies that align with the most critical transaction types as identified in the prioritization step.

5. The method of claim 4, wherein the generative AI engine utilizes a reinforcement learning algorithm to iteratively improve the conditional execution logic within the dynamic smart contracts based on historical network performance data.

6. The method of claim 5, wherein the deployment of dynamic smart contracts includes a verification process to ensure smart contracts' conditional logic is compliant with a current operational state of the target distributed ledgers.

7. The method of claim 6, wherein the job orchestration engine is configured to execute a real-time comparison between scheduled job execution and actual job performance to identify discrepancies.

8. The method of claim 7, wherein the feedback provided includes predictive analysis based on trend data to preemptively adjust job execution parameters in anticipation of network load changes.

9. A distributed ledger job scheduling system comprising:
a data reception module configured to autonomously receive and interpret transactional and operational data from multiple nodes within a distributed ledger network;
an analysis module linked to the data reception module, the analysis module configured to process received data to ascertain job execution parameters based on current network conditions and predefined business rules;
a quantum computing module operatively coupled to the analysis module, the quantum computing module comprising a photonic processor capable of performing quantum computations to optimize job scheduling strategies based on the execution parameters;
a generative artificial intelligence (AI) module configured to receive optimized strategies from the quantum computing module and generate dynamic smart contracts that encode job scheduling rules tailored to optimize transaction throughput, reduce latency, and efficiently allocate network bandwidth and storage resources;
an orchestration module communicatively connected to the AI module, the orchestration module adapted to deploy the generated smart contracts to the distributed ledger and initiate job execution in accordance with the scheduling rules; and
a monitoring module configured to continuously evaluate the execution of jobs on the distributed ledger, provide feedback to the analysis module, and adjust the job execution parameters in real time, wherein the orchestration module dynamically updates the job scheduling in response to the feedback to maintain optimal network operation.

10. The system of claim 9, wherein the data reception module is further configured to filter transactional data based on transaction type, size, or priority status.

11. The system of claim 10, wherein the analysis module includes a business logic interpreter capable of adapting the job execution parameters in real time based on changes in the predefined business rules and the filtered transactional data.

12. The system of claim 11, wherein the quantum computing module comprises a photonic quantum processor integrated with an annealing mechanism for solving optimization problems related to job scheduling derived from the adapted job execution parameters.

13. The system of claim 12, wherein the AI module includes a neural network trained to predict future network conditions based on historical data patterns and the received optimized strategies from the photonic quantum processor.

14. The system of claim 13, wherein the orchestration module is further configured to sequence job execution across multiple distributed ledgers to balance the network load, based on predictions made by the neural network.

15. The system of claim 14, wherein the dynamic smart contracts generated by the AI module include provisions for conditional execution based on real-time network bandwidth availability, as sequenced by the orchestration module.

16. The system of claim 15, wherein the monitoring module utilizes distributed sensors across network nodes to gather comprehensive performance data for a feedback mechanism, influencing the conditional execution provisions in the dynamic smart contracts.

17. The system of claim 16, wherein the AI module is further configured to update the dynamic smart contracts autonomously in response to feedback indicating a deviation from optimal network performance, as determined by the monitoring module.

18. The system of claim 17, wherein the orchestration module includes a rollback feature to revert job schedules to a previous state in event of network failure or performance degradation, as indicated by updates from the AI module.

19. The system of claim 18, further comprising a user interface module to allow administrators to manually override the autonomous scheduling decisions made by the system, including rollback actions of the orchestration module.

20. An autonomous job scheduling system for managing tasks within a distributed ledger network, the system comprising:
a job analysis module configured to collect operational data from the distributed ledger, including transaction context, business rules, and network performance metrics;
a photonic quantum computing system communicatively coupled with the job analysis module, the quantum computing system configured to receive the operational data and execute quantum computations to derive optimized job scheduling strategies;
a generative AI engine interfaced with the quantum computing system, the generative AI engine configured to formulate dynamic smart contracts incorporating the optimized job scheduling strategies; and
a job orchestration engine operatively connected to the generative AI engine, the job orchestration engine adapted to deploy and execute the dynamic smart contracts on the distributed ledger, thereby scheduling jobs in accordance with the optimized strategies.
